(19) United States
(12) Patent Application Publication
(10) Pub. No.: US 2008/0203635 A1
(43) Pub. Date: Aug. 28, 2008

(54) Textile Spring

(75) Inventors: Pini Hascalovich, Haifa (IL); Boris Tokarsky, Nazareth Illit (IL)

Correspondence Address: Pearl Cohen Zedek Latzer, LLP, 1500 Broadway, 12th Floor, New York, NY, 10036, US

(73) Assignee: ESCOM COMPOSITE MATERIALS LTD., Migdal Ha'Emek (IL)

(21) Appl. No.: 11/792,422

(22) PCT Filed: Dec. 5, 2005
(86) PCT No.: PCT/IL2005/001303

§ 371 Date: Jan. 2, 2008

Related U.S. Application Data
(60) Provisional application No. 60/633,099, filed on Dec. 6, 2004.

(51) Int. Cl. F16F 1/36; B32B 5/04

(52) U.S. Cl. 267/148; 267/292

(57) ABSTRACT

A textile spring that comprises a textile core (2) and a cover over the outer surface of the textile core, such that the cover may be bonded or not bonded to the textile core, and upon application of compression load (4), the cover is compressed against the textile core, and the textile core contracts elastically. The textile spring may be in the form of a sandwich (1) that comprises two flexible face sheets (3), bonded to the upper and lower outer surfaces of the textile spring with a flexible adhesive.

### FIELD OF THE INVENTION

The present invention relates to springs, and more particularly to springs comprising a polymeric textile core.

### BACKGROUND

Springs are well known for a very long period of time. Ancient springs include leaf springs made of wood or metals. Later, as metallurgy advanced sufficiently, coil springs appeared, and eventually new springs made of elastomeric materials (e.g., rubber, neoprene, silicon) appeared.

Compression springs made from wire are widely used. Their important parameters are free length and solid height. The free length is the overall length in the unloaded position. The solid height is the length of the compression spring when a sufficient load brings all coils into contact with adjacent coils. Corresponding parameters may be defined for compression springs made from rubber or other elastic material. These springs usually comprise some layer that is laterally compressible. Instead of the term “height” (“free” or “solid”), it is better to use in this case the word “thickness”. A drawback of elastomeric compression springs is that the difference between the “solid” and “free” height (thicknesses) is limited. For example, the “solid” thickness of a rubber strip is nearly 80% of its “free” thickness.

It is an object of the present invention to provide a spring that is at the same time flexible and resistant.

It is another object of the present invention to provide a spring having a stiffness that is dependent on load.

It is another object of the present invention to provide a spring that is able to withstand high loads with a maximum compression of only a few percent relative to its initial thickness.

Still another object of the present invention is to provide a spring with a small specific density, and which is very light-weight.

Still another object of the present invention is to provide a spring in various planar and multi-dimensional shapes.

Still another object of the present invention is to provide a spring that is durable for long service terms, and particularly not affected by resonance, fatigue, or corrosion.

Still another object of the present invention is to provide a spring made of different kinds of fibrous materials, and that is tailored in accordance with its specific application and environment. Particularly, the spring may also be designed to be radar transparent, which makes it suitable for military applications requiring such quality.

### BRIEF DESCRIPTION OF THE DRAWINGS

FIG. 1 shows a textile spring comprising two flexible face sheets connected with a 3-D textile structure;

FIG. 2 shows the deformation behavior under load of a textile spring made of a thread of 0.5 mm in diameter; and

FIG. 3 shows the deformation behavior under load of a textile spring made of a thread of 0.3 mm in diameter.

### DETAILED DESCRIPTION OF THE DRAWINGS

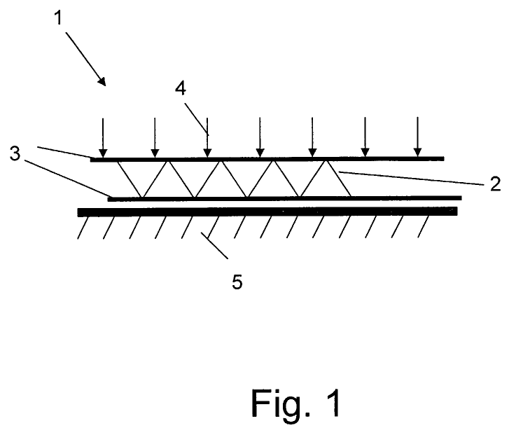

In FIG. 1, a spring structure is presented that is a sandwich structure (1). A textile spring of this type has to be flexible under compression, by taking the load (4) exerted upon the sandwich structure on the spring core (2). The two face sheets (3), bonded to two outer surfaces of the spring core, have to be, therefore, flexible as well in order for this structure to exhibit a spring behavior. The surface (5), positioned beneath the spring, may be a table or any other rigid flat surface. The textile spring is compressed to this surface upon application of a load perpendicular to the spring and surface.

Furthermore, the bonding at the interface between the face sheets and the textile spring core has to be flexible as well. The face sheets are, therefore, bonded only to the outer surface of the spring. As a result of application of a compression load, the thickness of the sandwich spring decreases substantially relative to its thickness without load (‘free’ thickness), depending upon the magnitude of the load employed, and the spring's elastic modulus. The face sheets in such a sandwich configuration have to be made of a flexible material, and their bonding to the textile core of the spring is carried out by welding or adhesion with a polymeric adhesive, which is also flexible. The use of flexible materials for both the face sheet and adhesive, therefore, enables the entire structure its flexibility necessary for carrying high loads without catastrophic or irreversible damage. Another method of bonding the face sheets to the textile core while preserving spring behavior is to immerse the lateral planes of the textile spring in a flexible polymer, thereby creating a flexible shell, which is integrally bonded to the core.

It should be noted though, that this sandwich configuration in all its forms is only a preferred embodiment of a textile spring of the present invention. In one case for example, when the spring is placed in a defined area between rigid planes, then it can be immersed in flexible foamed polymer in order to provide final finish to the spring structure, and protection from penetration of foreign bodies to the spring. In still another case, the core of the textile spring is placed as is between two rigid planes, without bonding face sheets to its outer planes or immersing it in a foamed polymer. In such cases the face sheets are not required. In still another case, only one flexible face sheet can be added to the textile spring core, when the plane that experiences the load is neither smooth nor uniform.

The quality of all types of the springs of the present invention is displayed upon multi-direction compression loading. That is, a spring of sandwich structure, for example, is always compressed from two sides, exhibiting its best quality in resistance to compression without yielding on the one hand, and on the other hand its elasticity which allows it to reversibly withstand repeated cycles of loading without fracturing or experiencing wear or any other permanent damage.

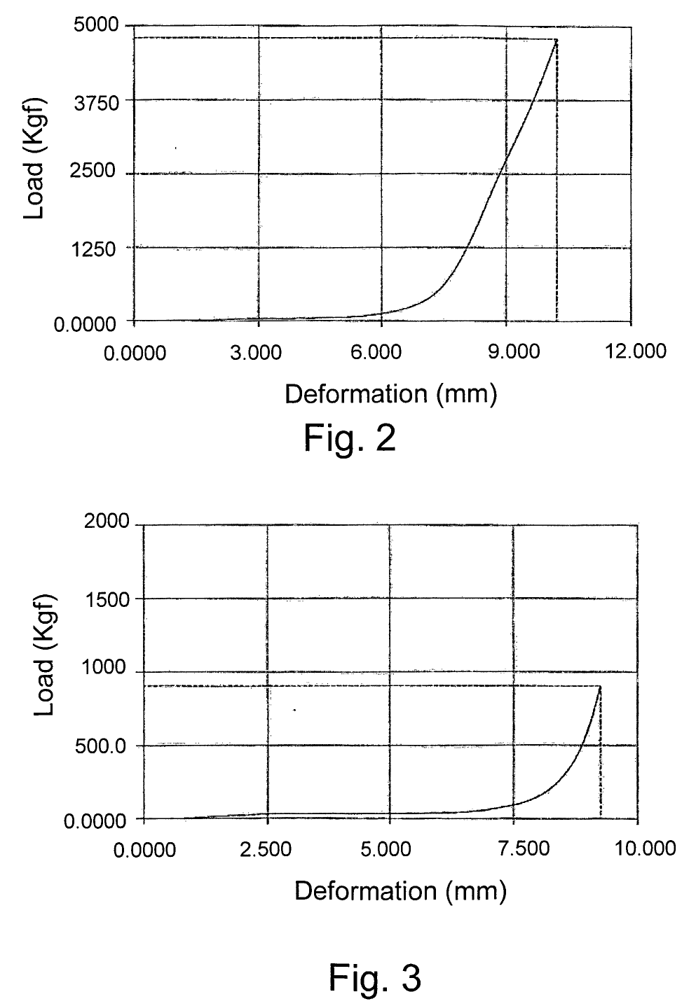

The deformation of a textile spring with compression was tested with increasing amounts of load, and the results are presented in FIGS. 2 and 3 in a graph. FIG. 2 displays the deformation in compression of a spring made of a filament with a diameter of 0.5 mm with the dimensions of 150 mm length (L), 50 mm width (W), 12 mm height (H) upon application of a load up to a maximum of 4750 Kg. FIG. 3 displays the deformation in compression of a spring made of a filament with a diameter of 0.3 mm with dimensions of 150 mm L×50 mm W×10 mm H. The maximum load on the sample in FIG. 3 reaches 905.5 Kg. Both springs were mounted on an INSTRON machine, and their contraction as a function of compression loading was tested. The surface of load application was 50×50 mm².

Maximal possible deformation of the samples in the relative tests (FIGS. 2 and 3) was 12 mm and 10 mm relatively. These values are equal to the “free” thickness of the corresponding samples. It is clear from the graphs that the deformation of the springs increases in a non linear way. It changes rapidly at relatively small compression loads, indicating high elasticity. The deformation of the spring as shown in graph (FIG. 2) increases 6 mm at very small loads. Afterwards, stiffness of spring increases dramatically. The same behavior is observed for the second spring (0.3 mm filament) as demonstrated in FIG. 3. Maximal achieved deformation in both tests is 10.21 and 9.25 accordingly, i.e. springs where compressed up to 15% and 7.5% from their “free” thickness correspondently. No residual deformation was noticed. The level of compression achieved was restricted by the initial defined maximal load. The conclusion is that the solid thickness may reach 5% to 10% of free thickness.

Analysis of these results teaches the superior elastic characteristic of the springs on the one hand, and their resistance to compression on the other hand. A spring of the present invention will, therefore, easily contract upon application of even small loads, but will essentially sustain its deformation close to that point of contraction even under extremely high loads without substantial change in its dimensions under compression.

Subsequent repeated cycles of loading were carried out with an apparatus comprising a pneumatic piston in order to set the springs resistance to fatigue and wear. This apparatus enables repeated loading of the springs according to requirements. After repeated loading, the springs are mounted again on the INSTRON machine, and their resistance to load is tested with the same procedure described above. The number of repeated cycles of loading which the spring are put through before the load test may be up to 10,000 cycles. In these particular cases, the springs were put through 100, 1000, 5,000 and 10,000 cycles before compression testing.

Table I below details several measured and calculated parameters examined in the load test. It can be seen that no irreversible damage or fracturing occurs in both spring samples, which successfully pass this test.

TABLE I

| | Parameter | |
|---|---|---|
| Sample | Spring 0.5 | Spring 0.3 |
| Fm (Applied Force) (Kgf) | 4795 | 905.5 |
| Fm (Force Normalized) (Kgf/mm²) | 0.1811 | 0.9589 |
| Deformation at Max. load (mm) | 10.21 | 9.253 |
| Agt (%) - deformation relative to free thickness | 85.11 | 92.53 |
| Load Rupture (Kgf) | 0.0000 — | 0.0000 — |
| Stress at Rupture - Normalized (Kgf/mm²) | 0.0000 — | 0.0000 — |
| Deformation Rupture (mm) | 0.0000 — | 0.0000 — |
| Sample width (mm) | 50.000 | 50.000 |
| Sample thickness (mm) | 100 | 100 |
| Sample length (mm) | 120.000 | 100.000 |
| Pass/Fail | Pass | Pass |

### SUMMARY OF THE INVENTION

The present invention aims at providing a new type of a compression spring, namely a textile spring.

In one aspect of the present invention, the space needed for a textile spring is approximately 10 times smaller than the relative space for conventional spring with the same resistance to load.

In one aspect, the present invention provides a textile spring comprising a textile core and a cover over at least one outer surface of the textile core, wherein the cover may be bonded or not bonded to the textile core, and wherein when the cover is bonded to the textile core then the cover and the bonding are flexible such that the textile core of the textile spring contracts elastically upon application of compression load.

In still another aspect, the present invention provides a textile spring according to claim 1, wherein said textile spring is in the form of a sandwich comprising two flexible face sheets bonded to the upper and lower outer surfaces of said textile spring with a flexible adhesive, and wherein the textile core, the face sheets, and the bonding between the textile core and the face sheets are flexible such that the contraction of the textile spring upon application of a compression load on at least one of its outer surfaces is essentially elastic and resistant to the applied load.

In one embodiment of the present invention, the spring structure is a sandwich structure. Since the textile spring has to be flexible under compression, by taking the load exerted upon the sandwich structure on the core spring, then the two face sheets have to be flexible as well in order for this structure to exhibit a spring behavior. Furthermore, the connection at the interface between the face sheets and the textile spring core has to be flexible as well, so that the applied load is passed on to the spring core. The face sheets are, therefore, bonded only to the outer surface of the spring. The face sheets in such a sandwich configuration have to be made of a flexible material, and their bonding to the textile core of the spring is carried out by welding or adhesion with a polymeric adhesive, which is also flexible. The use of flexible materials for both the face sheet and adhesive, therefore, enables the entire structure its flexibility necessary for carrying high loads without catastrophic or irreversible damage.

In still another embodiment of the present invention, the lateral planes of the textile spring are immersed in a flexible polymer, thereby creating a flexible shell, which is integrally bonded to the core.

In still another embodiment of the present invention, when the spring is placed in a defined area between rigid planes, then it is immersed in a flexible foamed polymer in order to provide final finish to the spring structure, and protection from penetration of foreign bodies to the spring. In such cases the face sheets are not required. Non-limitative examples of foamed polymer that may be used are PUR (Polyurethane), foamed acrylic polymers, and foamed PE (Polyethylene).

In still another embodiment of the present invention, the core of the textile spring is placed as is between two rigid planes, without bonding face sheets to its outer planes or immersing it in a foamed polymer.

In one embodiment of the present invention, only one flexible face sheet is added to the textile core spring, in cases where the plane experiencing the load is neither smooth nor uniform.

In one particular embodiment of the present invention the textile spring is in the form of a strip, which is compressed in the thickness direction, wherein the solid thickness of this spring is very small relative to its free thickness.

In one aspect of the present invention, only the area of the textile spring is essential, rather than its form in plane. Therefore, in one particular embodiment of the present invention, this feature allows the textile spring its manufacturing in 3-D complex shapes, and not only in plates.

The core filament from which the textile core of the spring is made of may be a synthetic material, preferably selected from Polyamide (Nylon), PE (Polyethylene), PP (Polypropylene), Polyester, Polyvinyl, Acryl, PC (Polycarbonate), Polystyrene, Carbon, Basalt, etc.

In another aspect of the present invention, the core filament is made of an anisotropic material, which is spatially oriented in the Z-axis, i.e., perpendicular to the face sheets. This property provides the core filament with an intrinsic resistance to compression. Anisotropic materials which the filament is made of are practically synthetic ones, which have a long range ordering in one preferred direction over the other two. Non-limitative examples of such materials are crystalline or semi-crystalline nylon 6, 6, isotactic polypropylene, and HDPE (High Density Polyethylene), Polyester, etc.

In one preferred embodiment of the present invention, the structure threads are made from an elastic polymer (e.g. nylon 6), which have a relatively high stiffness.

Despite the above, it is not to be construed that the present invention is limited in any way only to the use of anisotropically oriented materials for the fabrication of the filament core. Preferable materials may be selected from the following list:

Polyamide (e.g., PA 6), Polyester (e.g., PCT, PET, PTT), Polyurethane (e.g., PUR, EL, ED), Polyvinyl (e.g., CLF, PUDF, PVDC, PVAC), Acryl (PAN), Polyethylene, Polypropylene, Polycarbonate, PEEK (Polyether Ether Ketone), Polystyrene, Carbon, Basalt, etc.

As mentioned above, the face sheets and the interface between them and the textile spring core need to be flexible in order to impart an applied load to the core spring. Non-limitative examples are PP, PE, ABS (Acrylonitrile-Butadiene-Styrene), PC, TPR (Thermo Polymer Rubber), PUR, PVC, and silicon.

The adhesive, that is used to bond the face sheets to the textile core, may be any adhesive which comprises a flexible material. Particularly the adhesive may be selected from the group consisting of silicone adhesives, PUR, and acrylic adhesives. A preferable silicone adhesive that can be used in the present invention is a bi-component silicone-RTV (Room Temperature Vulcanization).

In another aspect of the present invention, the spring is compressed along its thickness axis to a thickness essentially very small relative to its initial thickness. In one particular embodiment, the maximum displacement experienced by a 10 mm thick textile spring of the present invention upon application of a high load is only 9.25 mm which is 7.75% of its “free” thickness, without reaching the maximal limit.

In still another aspect of the present invention, the stiffness of the textile spring is not constant but increases with increasing of a load. According to this the behavior of the textile spring is dependent on load, particularly exhibiting increasing dependence under application of high loads.

In still another aspect of the present invention, the textile spring may be specifically tailored according to requirements or application, and operate under a wide span of environmental conditions.

In still another aspect of the present invention, the textile spring, unlike metal springs, is not affected by resonance, namely repeating cycles of loading and unloading, fatigue, or corrosion.

Textile springs of the present invention may be used in a variety of applications. A non-limiting non-exhaustive list of applications comprises shock absorbers and suspension systems for cars machines and vibrating devices, energy absorbing fenders, anatomic shoe soles, and medical mattresses for hospitals.

In one particular embodiment of the present invention, the textile spring is Radar Transparent, a quality which makes it suitable for military applications that require such a demand.

One important quality of the textile springs of the present invention is their small specific density. The textile spring of the present invention is very light. In one particular embodiment of the present invention, the specific density varies from about 0.4 up to about 0.85 gr/cm³.

FIGS. 2 and 3 of the present application, demonstrate how the spring is compressed down to 5%-10% of its initial thickness. This property of the textile spring of the present invention is a very important advantage, particularly from the perspective of design.

By compression, the threads buckle and keep the sheets from drawing together. After reload, the spring returns to its initial thickness. According to the tests, repeatable cycles do not alter the properties of the textile spring.

A textile spring of the present invention has lower cost, lower weight, and lower height relative to other springs of equal efficiency. Corrosion or wear are absent. Implementation of the spring in any structure is also simple.

While examples of the invention have been described for purposes of illustration, it will be apparent that many modifications, variations and adaptations can be carried out by persons skilled in the art, without exceeding the scope of the claims.

1. A textile spring comprising a textile core comprising threads and at least one cover placed in contact over at least one outer surface of the textile core, wherein the threads are oriented in a Z-axis which is substantially perpendicular to the cover, and wherein upon application of compression load the cover is compressed against the textile core, and the textile core contracts elastically, exhibiting spring-like behavior.

2. A textile spring according to claim 1, wherein said at least one cover comprises two substantially opposite flexible face sheets bonded to opposite outer surfaces of said textile core with a flexible adhesive.

3. (canceled)

4. A textile spring according to claim 1, wherein said at least one cover is made from one or more a flexible materials selected from the group consisting of PP (Polypropylene), PE (Polyethylene), ABS (Acrylonitrile-Butadiene-Styrene), PC (Polycarbonate), TPR (Thermo Polymer Rubber), PUR (Polyurethane), PVC (Polyvinylchloride), and silicon.

5. A textile spring according to claim 2, wherein said flexible adhesive comprises a flexible material selected from the group consisting of silicon adhesives, PUR, and acrylic adhesives.

6. A textile spring according to claim 1, wherein the textile core of said textile spring is filled with polymer foam, said polymer foam covering the outer surface of said textile spring.

7. A textile spring according to claim 6, wherein said polymer foam is selected from the group consisting of foamed PUR (Polyure thane), foamed acrylic polymer, and foamed PE (Polyethylene).

8. A textile spring according to claim 1, wherein the textile core is placed between two rigid planes that are pressed to the core upon application of compression loading.

9. A textile spring according to claim 1, wherein the textile core of said textile spring is made of a synthetic material selected from the group consisting of Polyamide, Nylon, Nylon 6, 6, PE (Polyethylene), PP (Polypropylene), Polyester, Polyvinyl polymer, Acrylic polymer, PC (Polycarbonate), Polystyrene, Carbon, and Basalt.

10. A textile spring according to claim 9, wherein the synthetic material is spatially re-oriented in a direction perpendicular to the X-Y plane of said at least one cover.

11. A textile spring according to claim 9, wherein the synthetic material is anisotropic.

12. A sandwich structure with textile core according to claim 10, wherein the anisotropic synthetic material is selected from the group consisting of Polyamide (such as PA 6), Polyester (such as PCT, PET, PTT), Polyurethane (such as PUR, EL, ED), Polyvinyl (such as CLF, PUDF, PVDC, PVAC), Acryl (PAN), Polyethylene, Polypropylene, Polycarbonate, PEEK, Polystyrene, Carbon and Basalt.

13. A textile spring according to claim 1, wherein the specific density of said spring is in the range of about 0.4 to about 0.85 grams per cubic centimeter.

14. A textile spring according to claim 1, wherein the free thickness of said spring is compressed down to a solid thickness of about 5% to about 10% of its initial thickness.

15. A textile spring according to claim 1, wherein the textile spring is in the form of a strip, said strip being compressed in the thickness direction.

16. A textile spring according to claim 1, wherein the textile spring is in a three dimensional complex shape.

17. A textile spring according to claim 1, wherein the textile spring is not affected by repeating cycles of loading and unloading, fatigue, or corrosion.

18. A textile spring according to claim 1, wherein said textile spring is specifically tailored according to requirements or application, and operate under a wide span of environmental conditions.

19. A textile spring according to claim 1, wherein said textile spring is radar transparent.

20. Use of a textile spring according to claim 1 in the manufacturing of shock absorbers and suspension systems for cars machines and vibrating devices, energy absorbing fenders, anatomic shoe soles, and medical mattresses for hospitals.

21. (canceled)

22. An article of manufacture including a textile spring according to claim 1, said article of manufacture comprising an article selected from the group consisting of shock absorbers and suspension systems for cars machines and vibrating devices, energy absorbing fenders, anatomic shoe soles, and mattresses.
